(19) United States
(12) Patent Application Publication
(10) Pub. No.: US 2025/0353559 A1
(43) Pub. Date: Nov. 20, 2025

(54) SYSTEM AND METHOD FOR A DEPLOYABLE WIRING HARNESS

(71) Applicant: GM GLOBAL TECHNOLOGY OPERATIONS LLC, Detroit, MI (US)

(72) Inventors: Mark A. Smith, Huntington Woods, MI (US); Robert J. Kliffel, Farmington Hills, MI (US); Brian J. Haase, Warren, MI (US); Jeffrey A. Abell, Rochester Hills, MI (US); Vahidreza Molazadeh, Royal Oak, MI (US); Frank R. Kuehnl, Pinckney, MI (US); Jesse K. Trudell, Harrison Township, MI (US)

(73) Assignee: GM GLOBAL TECHNOLOGY OPERATIONS LLC, Detroit, MI (US)

(21) Appl. No.: 18/665,919

(22) Filed: May 16, 2024

(51) Int. Cl. B62D 65/02; B25J 9/10; B25J 18/02; B60R 16/02; H01B 7/00; H02G 1/06

(52) U.S. Cl. CPC B62D 65/02; B25J 9/106; B25J 18/025; B60R 16/0215; H02G 1/06; H01B 7/0045

(57) ABSTRACT

A deployable wiring harness system has a deployable wiring harness that includes insulated conductive cables with connectors assembled onto distal ends thereof. The insulated conductive cables are arranged as a lattice having segments joined at bendable nodes, wherein the segments are joined at the bendable nodes, and wherein the segments includes a machine-readable identifier. Also included is a wiring harness hanger that is affixed to one of the segments, and a wiring harness extender that is coupled to adjoined ones of the segments that are joined at the one of the bendable nodes. The wiring harness extender is arrangeable to urge the adjoined ones of the segments that are joined at the one of the bendable nodes towards a deployed state. An elongated stiffening member is affixed to respective insulated conductive cables of one of the segments at multiple locations.

### INTRODUCTION

The present disclosure relates to wiring harness systems, and methods for deploying a wiring harness into a chassis, such as a vehicle chassis.

Presently, vehicle wiring harnesses may be provided in a vehicle assembly plant as a wire bundle that may require a long, tedious process of identifying sections, unfolding, flipping, and pulling to achieve target positions. Wire harnesses bend, fold, twist and turn into arrangements that may require complex interpretation of their position and tedious yanking, unfolding, and flipping tasks to route to the target positions. This may result in increases in vehicle assembly time, may result in assembly errors, and may result in damage to the wiring harness requiring rework.

### SUMMARY

The concepts described herein provide a system, method, and apparatus related to a deployable wiring harness system, e.g., a main body wiring harness for a vehicle.

An aspect of the disclosure may include the deployable wiring harness system having a deployable wiring harness that includes a plurality of insulated conductive cables with connectors assembled onto distal ends thereof. The plurality of insulated conductive cables are arranged as a lattice having a plurality of segments joined at a plurality of bendable nodes, wherein the plurality of segments are joined at the plurality of bendable nodes, and wherein the plurality of segments includes a machine-readable identifier. Also included is a wiring harness hanger that is affixed to one of the plurality of segments, and a wiring harness extender that is coupled to adjoined ones of the plurality of segments that are joined at the one of the bendable nodes. The wiring harness extender is arrangeable to urge the adjoined ones of the plurality of segments that are joined at the one of the bendable nodes towards a deployed state. An elongated stiffening member is affixed to respective insulated conductive cables of one of the plurality of segments at multiple locations.

An aspect of the disclosure may include the deployable wiring harness being arrangeable in a collapsed state, wherein the collapsed state includes the plurality of segments of the lattice being folded at the plurality of bendable nodes; and the wiring harness extender being in a wound state.

Another aspect of the disclosure may include the deployable wiring harness being arrangeable in the deployed state, wherein the deployed state includes the plurality of segments of the lattice being unfolded at the plurality of bendable nodes; and the wiring harness extender being in a deployed state.

An aspect of the disclosure may include a deployable wiring harness for a vehicle chassis, which includes a plurality of insulated conductive cables having connectors assembled onto distal ends thereof. The plurality of insulated conductive cables are arranged as a lattice having a plurality of segments joined at a plurality of bendable nodes. The plurality of segments are joined at the plurality of bendable nodes, wherein one of the bendable nodes includes an extender, wherein the extender is arranged to urge adjoined ones of the plurality of segments that are joined at the one of the bendable nodes to an unfolded state, and wherein one of the plurality of segments includes an elongated stiffening member. The elongated stiffening member is rigidly secured at multiple locations to a respective insulated conductive cable of the one of the plurality of segments. Each of the plurality of segments includes a machine-readable identifier, each of the plurality of segments includes a retention tab; and each of the plurality of segments includes a hanger portion.

Another aspect of the disclosure may include one of the plurality of insulated conductive cables being a communication link.

Another aspect of the disclosure may include one of the plurality of insulated conductive cables being an electrical power link.

Another aspect of the disclosure may include the plurality of segments including a plurality of lateral segments and a plurality of longitudinal segments.

Another aspect of the disclosure may include the elongated stiffening member being a rigid rod, wherein the rigid rod is secured at multiple locations to respective ones of the plurality of insulated conductive cables of the one of the plurality of segments.

Another aspect of the disclosure may include the rigid rod being a sacrificial member that is removable subsequent to deployment of the deployable wiring harness into a vehicle chassis.

Another aspect of the disclosure may include the adjoined ones of the plurality of segments that are joined at the one of the bendable nodes including a first segment and a second segment that are joined at a pivot point; wherein the extender includes a first elongated member, a second elongated member, and a collapsible spring device; wherein the first elongated member is joined to the first segment; wherein the second elongated member is joined to the second segment; and wherein the collapsible spring device defines the pivot point.

Another aspect of the disclosure may include the extender being a latch spring having the first elongated member joined to the second elongated member via the collapsible spring device.

Another aspect of the disclosure may include the adjoined ones of the plurality of segments that are joined at the one of the bendable nodes including a first segment and a second segment that are joined at a pivot point; wherein the extender includes a shape memory alloy (SMA) device having a first elongated SMA member and a second elongated SMA member; wherein the first elongated SMA member is joined to the first segment; and wherein the second elongated SMA member is joined to the second segment.

Another aspect of the disclosure may include first respective insulated conductive cables of the first segment being disposed in a first conduit portion and second respective insulated conductive cables of the first segment being disposed in a second conduit portion; wherein the first elongated SMA member is affixed to the first conduit portion; and wherein the second elongated SMA member is affixed to the second conduit portion.

Another aspect of the disclosure may include the adjoined ones of the plurality of segments that are joined at the one of the bendable nodes including a first segment and a second segment that are joined at a pivot point; wherein the extender includes a collapsible pneumatic device having a first elongated pneumatic member and a second elongated pneumatic member; wherein the first elongated pneumatic member is joined to the first segment; and wherein the second elongated pneumatic member is joined to the second segment.

Another aspect of the disclosure may include first respective insulated conductive cables of the first segment being disposed in a first sheath portion and second respective insulated conductive cables of the first segment being disposed in a second sheath portion; wherein the first elongated pneumatic member is affixed to the first sheath portion; and wherein the second elongated pneumatic member is affixed to the second sheath portion.

Another aspect of the disclosure may include a wiring harness deployment system that includes a deployable wiring harness. The deployable wiring harness includes a plurality of insulated conductive cables having connectors assembled onto distal ends thereof, the plurality of insulated conductive cables being arranged as a lattice having a plurality of segments joined at a plurality of bendable nodes, wherein the plurality of segments are joined at the plurality of bendable nodes; wherein the plurality of segments includes a machine-readable identifier. The wiring harness deployment system also includes a wiring harness hanger, the wiring harness hanger being affixed to one of the plurality of segments of the deployable wiring harness. The wiring harness deployment system also includes a wiring harness extender, the wiring harness extender being coupled to adjoined ones of the plurality of segments that are joined at the one of the bendable nodes, wherein the wiring harness extender is arrangeable to urge the adjoined ones of the plurality of segments that are joined at the one of the bendable nodes towards a deployed state. The wiring harness deployment system also includes an elongated stiffening member, the elongated stiffening member being affixed to respective insulated conductive cables of one of the plurality of segments at multiple locations. The wiring harness deployment system also includes an expandable deployment device, wherein the wiring harness hanger of the deployable wiring harness is attachable to the expandable deployment device.

Another aspect of the disclosure may include the expandable deployment device being a two-dimensional (2D) scissoring extension device, wherein the 2D scissoring extension device is attachable to the deployable wiring harness via the wiring harness hanger.

Another aspect of the disclosure may include the expandable deployment device being a robotic arm having a 2D telescopic device, wherein the 2D telescopic device is attachable to the deployable wiring harness via the wiring harness hanger.

Another aspect of the disclosure may include the expandable deployment device being a three-dimensional (3D) umbrella extension device, wherein the 3D umbrella extension device is attachable to the deployable wiring harness via the wiring harness hanger.

Another aspect of the disclosure may include a method for deploying a deployable wiring harness into a vehicle chassis, which includes assembling the deployable wiring harness, including a plurality of insulated conductive cables having connectors assembled onto distal ends thereof, the plurality of insulated conductive cables being arranged as a lattice having a plurality of segments joined at a plurality of bendable nodes, wherein the plurality of segments are joined at the plurality of bendable nodes, wherein one of the bendable nodes includes an extender, the extender arrangeable to urge adjoined ones of the plurality of segments that are joined at the one of the bendable nodes towards an unfolded state; wherein one of the plurality of segments includes an elongated stiffening member, the elongated stiffening member being rigidly secured at multiple locations to respective insulated conductive cables of the one of the plurality of segments; wherein the plurality of segments includes a machine-readable identifier; wherein the plurality of segments includes a plurality of hanger portions. The plurality of segments are in a collapsed state, wherein the collapsed state includes the plurality of segments of the lattice being folded at the plurality of bendable nodes. The plurality of segments are suspended, via the plurality of hanger portions, in the collapsed state onto an extendable end effector. The plurality of segments that are suspended in the collapsed state are located, via the extendable end effector, proximal to the vehicle chassis. The extendable end effector extends the plurality of segments to an extended state. This includes urging, via the extender, the adjoined ones of the plurality of segments that are joined at the one of the bendable nodes to the unfolded state. The plurality of segments of the deployable wiring harness are deployed onto the vehicle chassis.

Another aspect of the disclosure may include removing the extender and the elongated stiffening member subsequent to the deploying of the plurality of segments onto the vehicle chassis.

The above summary is not intended to represent every possible embodiment or every aspect of the present disclosure. Rather, the foregoing summary is intended to illustrate some of the aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a top view of a deployable wiring harness arranged on a vehicle chassis, in accordance with the disclosure.

FIG. 2 schematically illustrates an isometric view of a telescopic arm with a deployable wiring harness, in accordance with the disclosure.

FIG. 3 schematically illustrates an isometric view of a telescopic arm arranged to deploy a deployable wiring harness within a portion of a vehicle chassis,, in accordance with the disclosure.

FIG. 4 schematically illustrates a wiring harness extender in the form of a latch spring extender, in accordance with the disclosure.

FIGS. 5A and 5B schematically illustrate wiring harness extenders in the form of spring-loaded stiffeners joined at bendable nodes, in accordance with the disclosure.

FIG. 6 schematically illustrates an expandable deployment device in the form of a two-dimensional (2D) scissor extender, in accordance with the disclosure.

FIG. 7 schematically illustrates an expandable deployment device in the form of a three-dimensional (3D) umbrella extender, in accordance with the disclosure.

The appended drawings are in simplified form and are not to precise scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The use of ordinals such as first, second and third does not necessarily imply a ranked sense of order, but may distinguish between multiple instances of an act or structure.

The following detailed description is merely illustrative in nature and is not intended to limit the application and uses. Furthermore, there is no intention to be bound by an expressed or implied theory presented herein.

Detailed embodiments of the present disclosure may be disclosed herein; however, it may be understood that the disclosed embodiments may be merely illustrative of the disclosure that may be embodied in various and alternative forms. Elements of some features may be exaggerated or minimized to show details of particular components. Therefore, specific structural and functional details disclosed herein may need not to be interpreted as limiting, but merely as a representative basis for teaching one skilled in the art to variously employ the present disclosure.

The present disclosure is susceptible of being embodied in various forms. Representative examples of the disclosure are shown in the drawings and described herein in detail as non-limiting examples thereof. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures, and are not intended to limit the scope of the disclosure.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, a serial peripheral interface (SPI) link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

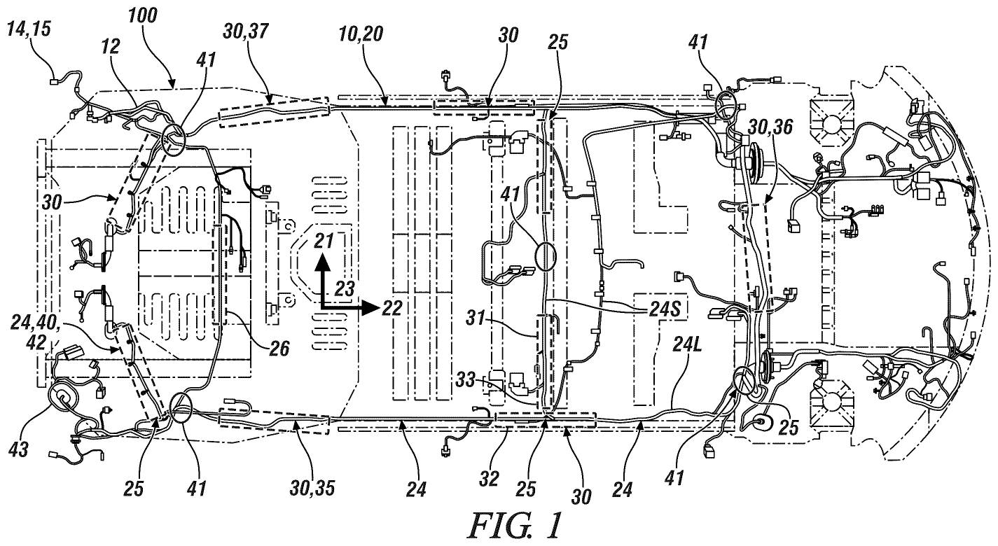

Referring to the drawings, wherein like reference numbers refer to the same or like components in the several Figures, FIG. 1 illustrates elements and concepts of a deployable wiring harness 10 that is deployable in and affixable to a chassis 100. The chassis 100 may be an element of a vehicle, wherein the vehicle includes, but is not limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. Alternatively, the chassis 100 may be an element of a stationary system, e.g., a computer network, a generator, a facility such as a vehicle charging system, etc., without limitation.

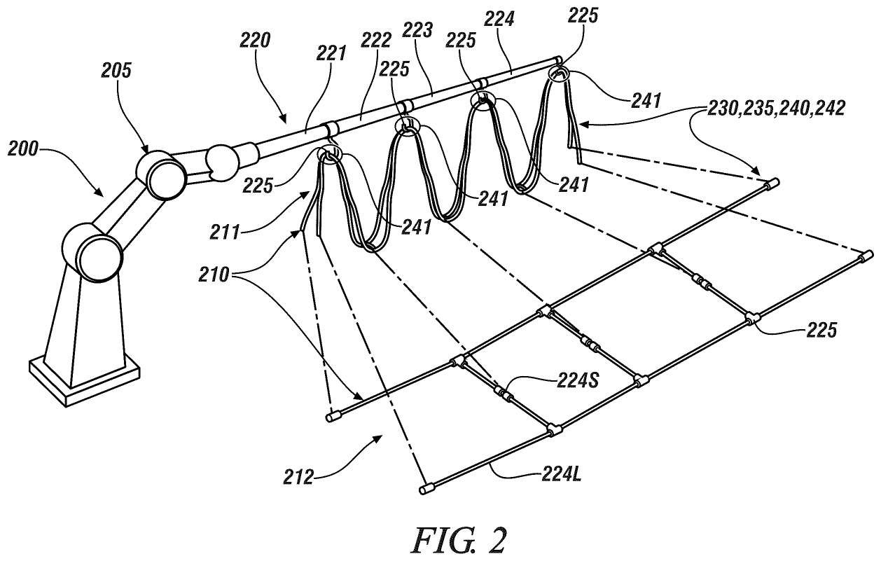

The deployable wiring harness 10 incorporates elements of a wiring harness deployment system 200, which is described with reference to FIG. 2, et seq. As used herein, “deploy” and derivative terms refer to hanging, lifting, transporting, moving into place, and otherwise handling a device, such as the deployable wiring harness.

Referring again to FIG. 1, the deployable wiring harness 10 may be arranged in a folded state and in an unfolded or deployed state (as illustrated). When in the deployed state, the deployable wiring harness 10 and chassis 100 define a lateral axis 21 and a longitudinal axis 22, with one or more portions of the deployable wiring harness 10 extending laterally, and one or more portions of the deployable wiring harness 10 extending longitudinally. In one non-limiting example, the lateral axis 21 and the longitudinal axis 22 extend along and define a horizontal plane 23. Elements of the deployable wiring harness 10, especially at distal ends thereof, may also extend vertically upward or downward from the horizontal plane 23.

The deployable wiring harness 10 includes a plurality of bundled, un-stripped, insulated conductive cables 12 that are fabricated from a conductive metal, e.g., copper, aluminum, alloys thereof, or another material. The end portion of each conductive cable 12 has a terminal 14 at a distal end 15 that is connected to a connector, a sensor, an actuator, a controller, or other element that is assembled onto a distal end thereof.

One or more of the conductive cables 12 may provide a communication link, which may be in the form of data signals that may include discrete, analog and/or digitized analog signals representing inputs from sensors, actuator commands, and communication between controllers. The term “signal” refers to a physically discernible indicator that conveys information, and may be a waveform such as DC, AC, sinusoidal-wave, triangular-wave, square-wave, pulsewidth-modulated square wave, vibration, and the like, that is capable of traveling through the respective conductive cable 12. One or more of the conductive cables 12 may provide a power link, which may be in the form of direct current (DC) or alternating current (AC) electrical power that is transferred therethrough to provide power for the sensors, actuators, and/or controllers. One or more of the conductive cables 12 may be sheathed to provide thermal insulation and provide supplemental mechanical protection to prevent or reduce likelihood of water or contaminant intrusion and mechanical harm such as pinching, etc. One or more of the conductive cables 12 may have shielding for insulation from electromagnetic interference. Pairs of the conductive cables 12 may be arranged as twisted pairs, or another arrangement.

The plurality of insulated conductive cables 12 of the deployable wiring harness 10 are arranged as a lattice 20 having a plurality of segments 24 that are joined at a plurality of bendable nodes 25. A schematic drawing of the deployable wiring harness 10 arranged as a lattice 20 is depicted with reference to FIG. 2, and depicts lateral segments 24S, longitudinal segments 24L, bending nodes 25, and hangers 41.

Referring again to FIG. 1, the plurality of segments 24 are joined at the plurality of bendable nodes 25. More specifically, adjoined ones of the plurality of segments 24 are joined at the one of the bendable nodes 25. Adjoined ones of the plurality of segments 24 may include a pair of lateral segments 24S, a pair of longitudinal segments 24L, a pair containing a single lateral segment 24S and a single longitudinal segment 24L, or a plurality of the segments 24 that includes one or multiple lateral segments 24S and one or multiple longitudinal segments 24L, or another combination of the segments 24.

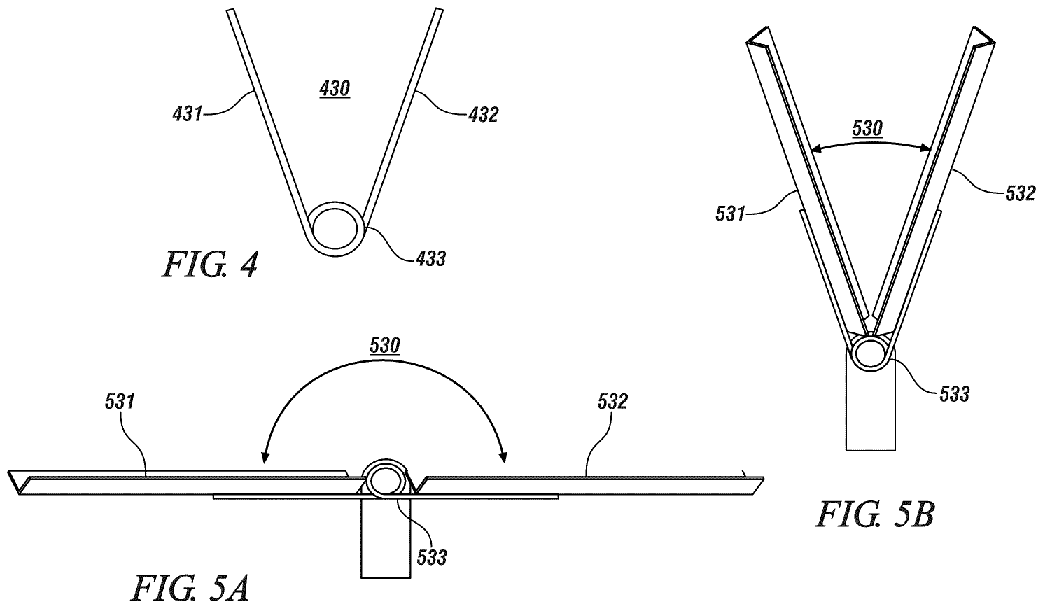

One or multiple wiring harness extenders (extender) 30 is integrated into the deployable wiring harness 10 at one or more of the bendable nodes 25 and/or the segments 24 that are adjoined thereto. Examples of extenders 30 are illustrated with reference to FIG. 4 (latch spring 430) and FIG. 5 (spring-loaded stiffener 530).

The extender 30 is composed as a device having a first arm 31 and a second arm 32 that are joined at a pivot point 33. When integrated into the deployable wiring harness 10, the pivot point 33 corresponds to the respective bendable node 25, and the first and second arms 31, 32 correspond to the respective adjoined segments 24.

In one embodiment, the extender 30 includes the first arm 31 being a first elongated rigid member, and the second arm 32 being an elongated rigid member, with the pivot point 33 being a collapsible spring device.

When the deployable wiring harness 10 is in the folded state, the plurality of segments 24 and corresponding first and second arms 31, 32 are folded or otherwise collapsed and the extender 30 is in a wound state and under tension. The plurality of segments 24 and corresponding first and second arms 31, 32 may be secured in the collapsed state via removable clips or other elements.

The extender 30 may be a latch spring, a hinged spring, or another similar device. Alternatively, or in addition, in one embodiment the extender 30 may include shape memory alloy (SMA) components that are actively or passively actuated (via temperature) to extend during deployment of the deployable wiring harness 10. When the extender 30 includes an SMA device, the SMA device has a first elongated SMA member that is joined to a second elongated SMA member at one of the bendable nodes 25. The first elongated SMA member may be joined to a first of the segments 24, and the second elongated SMA member may be joined to a second of the segments 24 that adjoins the first of the segments 24.

Alternatively, or in addition, the extender 30 may include pneumatically-activated stiffening components 37 that are actively or passively inflated to extend during deployment of the deployable wiring harness 10, and thus urge corresponding extension of the attached respective segments 24. In one embodiment, the extender 30 is an expandable device, analogous to a balloon, that expands and becomes rigid in response to internally applied air pressure.

The extender 30 is integrated into the deployable wiring harness 10 during fabrication thereof, with the extender 30 being placed under tension during preparation of the deployable wiring harness 10 for shipping.

The extender 30 is arranged to urge adjoined respective segments 24 that are joined at the one of the bendable nodes 25 to the unfolded state. This may include the extender 30 being capable of unfolding, unbending, extending, expanding, spreading out, opening out, flattening, or otherwise moving the adjoined ones of the plurality of segments 24.

One or more of the plurality of segments 24 includes an elongated stiffening member 35, which is advantageously secured thereto at multiple locations along its length. The elongated stiffening member 35 may be composed as a rigid fiberglass rod, an L-shaped cardboard channel, or another rigid member. The elongated stiffening member 35 may be a permanent element of the deployable wiring harness 10 that stays in place after deployment of the deployable wiring harness 10 in the chassis 100, including being integrated into a protective sheath 36 of the respective segment 24. Alternatively, the elongated stiffening member 35 may be a sacrificial element of the deployable wiring harness 10 that is removed and reused, recycled, or disposed of after deployment of the deployable wiring harness 10 in the chassis 100.

Each of the elongated stiffening members 35 is rigidly secured at multiple locations to a respective insulated conductive cable of the one of the plurality of segments.

Alternatively, one or more of the plurality of segments 24 is disposed in a conduit 26, with one or more elongated stiffening members 35 being rigidly secured at multiple locations to the conduit 26.

One or a plurality of the segments 24 may include a machine-readable identifier 43, which may be a QR code, a bar code, radiofrequency (RF) transponder, an alphanumeric character, or another device or element arranged to identify the segment.

One or a plurality of the segments 24 may include a retention tab 40 and/or a strain relief member 42, and may include one or a plurality of cable ties, clips, grommets, etc., for securing the cable bundles and preventing excessive bending or tension on the cables and connectors.

Stated differently, the extender 30 may include one or more stiffening elements 35 and/or unfolding members that are integrated into the deployable wiring harness 10, including, e.g., rigid channels, dowels, cardboard devices, collapsible/extendable devices such as spring-loaded devices, SMAs, pneumatic devices, magnetic devices, etc. One or more of the stiffening elements 35 may be a sacrificial device that is removed and discarded after deployment of the deployable wiring harness 10 in one embodiment. One or more of the stiffening elements 35 may be a permanent device that is installed into the chassis 100 as an element of the deployable wiring harness 10.

One or a plurality of the segments 24 may include a hanger portion 41, which may be in the form of an S-hook, a fishhook, etc., that are useable for deployment of the deployable wiring harness 10, i.e., for lifting, transporting, hanging, moving into place with an extendable arm that may be robotic.

FIGS. 2, 3, 4, 5A, 5B, 6, and 7 schematically illustrate elements of the deployable wiring harness 10 and wiring harness deployment system 200 that may be advantageously employed to deploy an embodiment of the deployable wiring harness 10 into the chassis 100, as intimated with reference to FIG. 1

The wiring harness deployment system 200 is composed with the deployable wiring harness 10 with one or multiple wiring harness hangers 41, one or multiple wiring harness extenders 30, and/or one or multiple elongated stiffening members 35, as described with reference to FIG. 1.

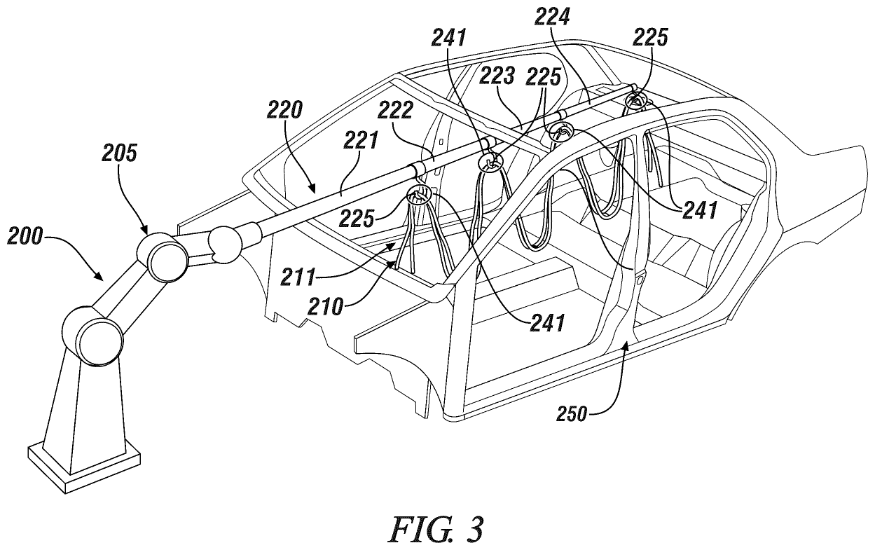

FIGS. 2 and 3 schematically illustrate elements of an embodiment of the wiring harness deployment system 200 that includes a robotic arm 205 having a telescopic arm 220, which is arranged for suspending and deploying an embodiment of the deployable wiring harness 210. The telescopic arm 220 includes a plurality of extendable/collapsible telescoping portions 221, 222, 223, and 224. One or multiple attachment points 225 descend from the plurality of extendable/collapsible telescoping portions 221, 222, 223, and 224, and are attachable to one or multiple hanger portions 241 of the deployable wiring harness 210, thus suspending the deployable wiring harness 210 from the telescopic arm 220. The deployable wiring harness 210 may be suspended from the telescopic arm 220 in either the first or folded state or the second or extended state for deployment in a chassis 250, as shown with reference to FIG. 3. In one embodiment, the robotic arm 205 includes a controller, sensors, and actuators (not shown), wherein one or multiple algorithms execute to control location, position, etc., of the robotic 205 to control the telescopic arm 220 to deploy the wiring harness 210 into the chassis 250.

The deployable wiring harness 210 is depicted in a first, folded state 211, and also in a second, deployed state 212.

The deployable wiring harness 210 includes a plurality of segments, including a plurality of longitudinal segments (a single one indicated) 224L and a plurality of lateral segment (a single one indicated) 224S. The deployable wiring harness 210 is equipped with one or multiple extenders 230, one or multiple elongated stiffening members 235, one or multiple retention tabs 240, one or multiple strain relief members 242, and one or multiple hanger portions 241.

When the deployable wiring harness 210 is in the first or folded state 211, the one or multiple extenders 230 are in their respective folded or collapsed states.

When the deployable wiring harness 210 is in the second or deployed state 212, the one or multiple extenders 230 are in their respective deployed states.

This arrangement facilitates the deployable wiring harness 210 being suspended in the folded state 211 from the telescopic arm 220 of the robotic arm 205, and being positioned by the robotic arm 205 in the chassis 250, with the telescopic arm 220 being in a collapsed or non-extended state. The telescopic arm 220 may be expanded, along with activation of the one or multiple extenders 230 to deploy the deployable wiring harness 210 in the chassis 250. The one or multiple extenders 230, one or multiple elongated stiffening members 235, one or multiple retention tabs 240, one or multiple strain relief members 242, in conjunction with the extended telescopic arm 220, facilitate accurate placement of the one or multiple extenders 230, one or multiple elongated stiffening members 235, one or multiple retention tabs 240, one or multiple strain relief members 242, and one or multiple hanger portions 241 in the chassis 250 at various points. FIG. 4 schematically illustrates an embodiment of the latch spring 430 having first arm 431 and second arm 432 that are joined at pivot point 433.

FIGS. 5A and 5B schematically illustrate an embodiment of the spring-loaded stiffener 530 having a first extended arm 531 and second extended arm 532 that are joined at spring 533. FIG. 5A depicts the spring-loaded stiffener 530 in the deployed state, with spring 533 in the deployed state and first and second extended arms 531 and 532 being extended. When coupled to or connected to segments of an embodiment of the wiring harness described herein, the corresponding segments are unfolded and arranged for deployment. FIG. 5B depicts the spring-loaded stiffener 530 in the folded or collapsed state, with spring 533 in the collapsed state and first and second extended arms 531 and 532 being folded into close proximity with each other. When coupled to or connected to segments of an embodiment of the wiring harness described herein, the corresponding segments are folded and arranged for storage and shipping.

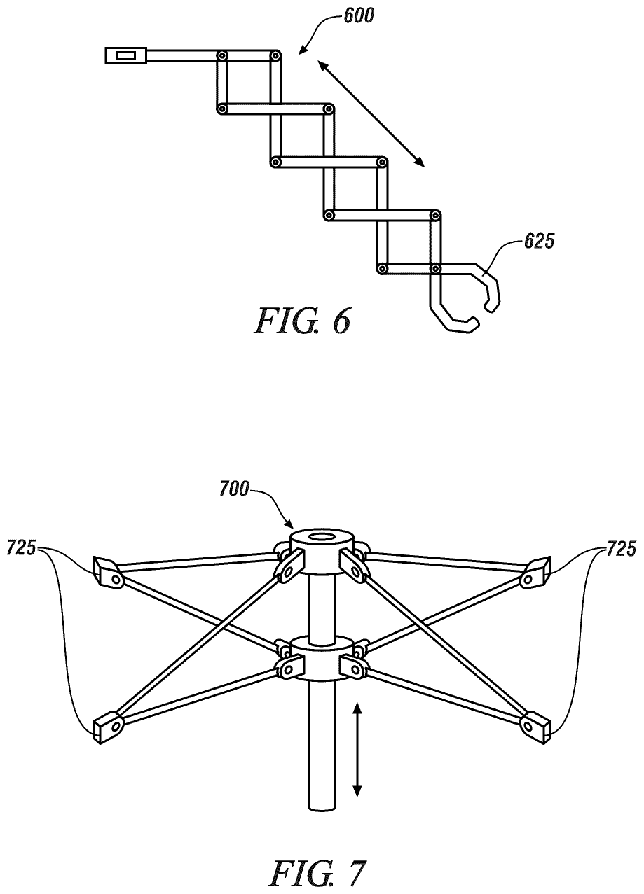

FIG. 6 schematically illustrates an embodiment of the expandable deployment device 600, which is arranged as a two-dimensional (2D) scissoring extension device. One or multiple attachment points 625 descend from the 2D scissoring extension device 600, and are attachable to the one or multiple wiring harness hangers of the deployable wiring harness, thus suspending the deployable wiring harness. The harness can be suspended from the 2D scissoring extension device 600 in either the collapsed state or the extended state for deployment in the chassis.

FIG. 7 schematically illustrates an embodiment of the expandable deployment device 700, which is arranged as a three-dimensional (3D) umbrella extension device. One or multiple attachment points 725 descend from the 3D umbrella extension device 700, and are attachable to the one or multiple wiring harness hangers of the deployable wiring harness, thus suspending the deployable wiring harness. The deployable wiring harness can be suspended from the 3D umbrella extension device 700 in either the collapsed state or the extended state for deployment in the chassis.

In this manner, assembly time spent deploying a wiring harness into a chassis may be reduced, and assembly errors may be reduced.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A deployable wiring harness system, comprising:
a deployable wiring harness, the deployable wiring harness including a plurality of insulated conductive cables having connectors assembled onto distal ends thereof, the plurality of insulated conductive cables being arranged as a lattice having a plurality of segments joined at a plurality of bendable nodes, wherein the plurality of segments are joined at the plurality of bendable nodes; wherein the plurality of segments includes a machine-readable identifier;
a wiring harness hanger, the wiring harness hanger being affixed to one of the plurality of segments;
a wiring harness extender, the wiring harness extender being coupled to adjoined ones of the plurality of segments that are joined at the one of the bendable nodes, wherein the wiring harness extender is arrangeable to urge the adjoined ones of the plurality of segments that are joined at the one of the bendable nodes towards a deployed state; and
an elongated stiffening member;
wherein the elongated stiffening member is affixed to respective insulated conductive cables of one of the plurality of segments at multiple locations.

2. The system of claim 1, further comprising:
the deployable wiring harness being arrangeable in a collapsed state, wherein the collapsed state includes:
the plurality of segments of the lattice being folded at the plurality of bendable nodes; and
the wiring harness extender being in a wound state.

3. The system of claim 1, further comprising:
the deployable wiring harness being arrangeable in the deployed state, wherein the deployed state includes:
the plurality of segments of the lattice being unfolded at the plurality of bendable nodes; and
the wiring harness extender being in a deployed state.

4. The system of claim 1, wherein one of the plurality of insulated conductive cables comprises a communication link.

5. The system of claim 1, wherein one of the plurality of insulated conductive cables comprises an electrical power link.

6. The system of claim 1, wherein the plurality of segments includes a plurality of lateral segments and a plurality of longitudinal segments.

7. The system of claim 1, wherein the elongated stiffening member comprises a rigid rod, wherein the rigid rod is secured at multiple locations to respective ones of the plurality of insulated conductive cables of the one of the plurality of segments.

8. The system of claim 7, wherein the rigid rod comprises a sacrificial member that is removable subsequent to deployment of the deployable wiring harness into a vehicle chassis.

9. The system of claim 1, wherein the adjoined ones of the plurality of segments that are joined at the one of the bendable nodes includes a first segment and a second segment that are joined at a pivot point;
wherein the wiring harness extender includes a first elongated member, a second elongated member, and a collapsible spring device;
wherein the first elongated member is joined to the first segment;
wherein the second elongated member is joined to the second segment; and
wherein the collapsible spring device defines the pivot point.

10. The system of claim 9, wherein the wiring harness extender comprises a latch spring having the first elongated member joined to the second elongated member via the collapsible spring device.

11. The system of claim 1:
wherein the adjoined ones of the plurality of segments that are joined at the one of the bendable nodes includes a first segment and a second segment that are joined at a pivot point;
wherein the wiring harness extender includes a shape memory alloy (SMA) device having a first elongated SMA member and a second elongated SMA member;
wherein the first elongated SMA member is joined to the first segment; and
wherein the second elongated SMA member is joined to the second segment.

12. The system of claim 11, further comprising first respective insulated conductive cables of the first segment being disposed in a first conduit portion and second respective insulated conductive cables of the first segment being disposed in a second conduit portion;
wherein the first elongated SMA member is affixed to the first conduit portion; and
wherein the second elongated SMA member is affixed to the second conduit portion.

13. The system of claim 1:
wherein the adjoined ones of the plurality of segments that are joined at the one of the bendable nodes includes a first segment and a second segment that are joined at a pivot point;
wherein the wiring harness extender includes a collapsible pneumatic device having a first elongated pneumatic member and a second elongated pneumatic member;
wherein the first elongated pneumatic member is joined to the first segment; and
wherein the second elongated pneumatic member is joined to the second segment.

14. The system of claim 13, further comprising first respective insulated conductive cables of the first segment being disposed in a first sheath portion and second respective insulated conductive cables of the first segment being disposed in a second sheath portion;
wherein the first elongated pneumatic member is affixed to the first sheath portion; and
wherein the second elongated pneumatic member is affixed to the second sheath portion.

15. A wiring harness deployment system, comprising:
a deployable wiring harness, the deployable wiring harness including a plurality of insulated conductive cables having connectors assembled onto distal ends thereof, the plurality of insulated conductive cables being arranged as a lattice having a plurality of segments joined at a plurality of bendable nodes, wherein the plurality of segments are joined at the plurality of bendable nodes; wherein the plurality of segments includes a machine-readable identifier;
a wiring harness hanger, the wiring harness hanger being affixed to one of the plurality of segments;
a wiring harness extender, the wiring harness extender being coupled to adjoined ones of the plurality of segments that are joined at the one of the bendable nodes, wherein the wiring harness extender is arrangeable to urge the adjoined ones of the plurality of segments that are joined at the one of the bendable nodes towards a deployed state;
an elongated stiffening member, the elongated stiffening member being affixed to respective insulated conductive cables of one of the plurality of segments at multiple locations; and
an expandable deployment device;
wherein the wiring harness hanger of the deployable wiring harness is attachable to the expandable deployment device.

16. The wiring harness deployment system of claim 15, wherein the expandable deployment device comprises a two-dimensional (2D) scissoring extension device;
wherein the 2D scissoring extension device is attachable to the deployable wiring harness via the wiring harness hanger.

17. The wiring harness deployment system of claim 15, wherein the expandable deployment device comprises a robotic arm having a 2D telescopic device;
wherein the 2D telescopic device is attachable to the deployable wiring harness via the wiring harness hanger.

18. The wiring harness deployment system of claim 15, wherein the expandable deployment device comprises a three-dimensional (3D) umbrella extension device;
wherein the 3D umbrella extension device is attachable to the deployable wiring harness via the wiring harness hanger.

19. A method for deploying a deployable wiring harness, the method comprising:
fabricating a deployable wiring harness, the deployable wiring harness including a plurality of insulated conductive cables having connectors assembled onto distal ends thereof, the plurality of insulated conductive cables being arranged as a lattice having a plurality of segments joined at a plurality of bendable nodes, wherein the plurality of segments are joined at the plurality of bendable nodes;
affixing a wiring harness hanger to one of the plurality of segments;
coupling a wiring harness extender to adjoined ones of the plurality of segments that are joined at the one of the bendable nodes, wherein the wiring harness extender is arrangeable to urge the adjoined ones of the plurality of segments that are joined at the one of the bendable nodes towards a deployed state;
affixing an elongated stiffening member to respective insulated conductive cables of one of the plurality of segments at multiple locations;
arranging the deployable wiring harness in a collapsed state, wherein the collapsed state includes the plurality of segments of the lattice being folded at the plurality of bendable nodes, and the wiring harness extender being in a wound state;
suspending, via the wiring harness hanger, the deployable wiring harness to an end effector of an arm; and
deploying, via the end effector of the arm, the deployable wiring harness, including unfolding the plurality of segments of the lattice at the plurality of bendable nodes and controlling the wiring harness extender to the deployed state.

20. The method of claim 19, wherein the arm comprises a telescopic arm, and wherein deploying, via the end effector of the arm, the deployable wiring harness further comprises extending the telescopic arm to extend the deployable wiring harness to the deployed state.
